(19) United States
(12) Patent Application Publication
(10) Pub. No.: US 2026/0017126 A1
(43) Pub. Date: Jan. 15, 2026

(54) SYSTEMS AND METHODS FOR USING MULTI-TIERED GUARDRAIL ARCHITECTURE TO GENERATE DYNAMIC CONVERSATIONAL RESPONSES IN SPARSE DATA ENVIRONMENTS

(71) Applicant: Capital One Services, LLC, McLean, VA (US)

(72) Inventors: Melissa KAZEMI RAD, Elmsford, NY (US); Mohammad SOROWER, Great Falls, VA (US); Paresh DASHORE, Arlington, VA (US); Andy LUO, New York, NY (US)

(73) Assignee: Capital One Services, LLC, McLean, VA (US)

(21) Appl. No.: 18/771,837

(22) Filed: Jul. 12, 2024

(51) Int. Cl. G06F 11/07; G06F 11/34

(52) U.S. Cl. CPC G06F 11/0769; G06F 11/3438

(57) ABSTRACT

Systems and methods for uses and/or improvements to artificial intelligence applications, particularly in the area of generating conversational dynamic responses. As one example, systems and methods are for generating conversational dynamic responses using a multi-tiered guardrail architecture. As one example, systems and methods are for generating conversational dynamic responses using a multi-tiered guardrail architecture in data sparse environments.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations.

One area in which artificial intelligence has advanced seemingly overnight, is with respect to chatbot applications. Chatbots are software applications designed to simulate human conversation and interact with users through text or voice. They are commonly used in customer service, information retrieval, and various other contexts where automated interaction with humans can be beneficial. In many instances, these chatbots use artificial intelligence, particularly natural language processing (NLP) and machine learning (ML), particularly large language models (LLMs), to understand and respond to user inputs more flexibly and contextually.

However, despite these benefits and despite the wide-ranging number of potential applications, practical implementations of artificial intelligence have been hindered by several problems. First, models can generate incorrect or misleading information. They do not have a built-in mechanism for verifying facts, which can lead to the propagation of false information. They can also produce “hallucinations,” where the model fabricates details or entire responses that seem plausible but are entirely false. Models can also inherit and even amplify biases present in their training data. This includes biases related to race, gender, culture, and more. They may inadvertently produce outputs that are prejudiced, discriminatory, or offensive. Finally, while models can generate contextually relevant text, they do not understand the content in the way humans do. This can lead to responses that are contextually inappropriate or lacking in deeper insight. They may struggle with tasks requiring a nuanced understanding of the context, sarcasm, or humor. These technical problems may present an inherent problem with attempting to use an artificial intelligence-based solution to generate conversational dynamic responses.

### SUMMARY

Systems and methods are described herein for novel uses and/or improvements to artificial intelligence applications, particularly in the area of generating conversational dynamic responses. As one example, systems and methods are described herein for generating conversational dynamic responses that overcome the inherent technical problems described above. Furthermore, the systems and methods overcome these inherent technical problems even in data sparse environments.

For example, existing systems may attempt to overcome the aforementioned technical problems through increased model training. However, a reliance on increased model training to overcome these technical problems raises additional technical hurdles. First, artificial intelligence already relies on large amounts of high-quality data, and the process for obtaining this data and ensuring it is high-quality can be complex and time-consuming. Additionally, data that is obtained needs to be objective specific requiring careful categorizing and accurate labeling. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results, eliminating bias, and/or reducing hallucinations. These technical problems may present an inherent problem with attempting to use additional training data to overcome the aforementioned technical problems.

To overcome these technical deficiencies in adapting artificial intelligence models for this practical benefit as well as doing so in data sparse environments, the systems and methods use a novel model architecture featuring multi-tiered guardrails. For example, as opposed to training models to eliminate responses featuring inaccuracies, responses lacking contextual understanding, responses featuring hallucinations, and/or responses featuring bias, the architecture uses a series of multi-tiered guardrails. Moreover, as opposed to subjecting an ultimate output of the model to the series of guardrails (e.g., as a filtering mechanism), the architecture incorporates a step-wise architecture with feedback loops at each tier. By doing so, the systems and methods can generate conversational dynamic responses that overcome the inherent technical problems described above even in data sparse environments.

In some aspects, systems and methods of generating conversational dynamic responses using a multi-tiered guardrail architecture in data sparse environments are described. For example, the system may receive a first user action, at a user interface, of an application. The system may process the first user action through an artificial intelligence model, wherein processing the artificial intelligence model comprises: generating a first input based on the first user action; processing the first input through a first tier of the artificial intelligence model to generate a first output or a first error, wherein the first tier of the artificial intelligence model comprises a first guardrail, and wherein the first guardrail compares the first user action to a listing of prohibited user actions to determine whether to generate the first output or the first error; in response to determining to generate the first output, generating a second input based on the first output; processing the second input through a second tier of the artificial intelligence model to generate a second output or a second error, wherein the second tier of the artificial intelligence model comprises a second guardrail, wherein the second guardrail compares one or more text strings corresponding to the second input to a contextual relevance threshold to determine whether to generate the second output or the second error; and in response to determining to generate the second output, generating a first dynamic conversational response.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for generating conversational dynamic responses, in accordance with one or more embodiments.

FIG. 2 shows an illustrative diagram for a multi-tiered guardrail architecture, in accordance with one or more embodiments.

FIG. 3 shows illustrative components for a system used to generate conversational dynamic responses, in accordance with one or more embodiments.

FIG. 4 shows a flowchart of the steps involved in generating conversational responses, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

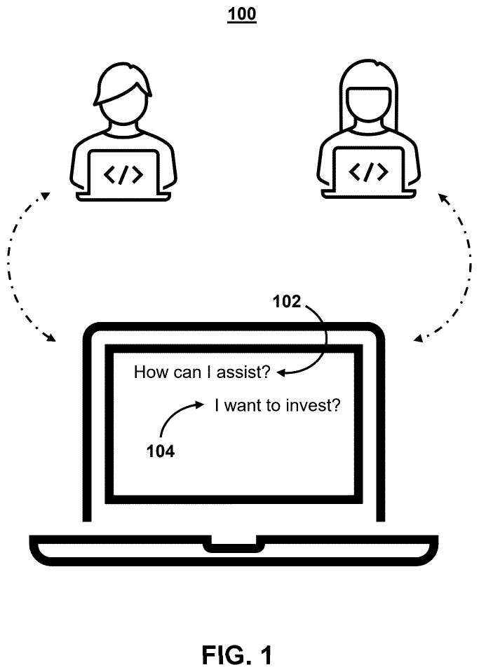

FIG. 1 shows an illustrative diagram for generating conversational dynamic responses, in accordance with one or more embodiments. In some embodiments, system 100 may be used to generate conversational dynamic responses using a multi-tiered guardrail architecture in data sparse environments. For example, system 100 may include a user interface that generates response 102 and response 104.

As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

When a user inputs a query, the system first preprocesses the text to normalize it, tokenize it, and extract key entities and intents using natural language processing (NLP) techniques. The system may use one or more models for identifying relevant entities and intent classification models for understanding the user's intent. Once the input is understood, the system uses predefined rules, templates, or machine learning models, such as neural networks or transformer-based models, to generate a coherent and contextually relevant response. This response generation process leverages embedding techniques to capture the semantic meaning of the input and align it with potential responses.

The generated response may then be formatted appropriately for the user interface, considering factors like readability and user experience. The system might also incorporate additional features such as dynamic content fetching from databases or APIs to provide real-time and personalized information. Finally, the response may be rendered in the user interface, which could be a chat window, a voice assistant, or any other interactive platform. The interface ensures that the response is presented in a user-friendly manner, possibly including text, images, or interactive elements to enhance the overall user experience. Throughout this process, the system maintains a feedback loop, learning from user interactions to improve future responses and ensure ongoing relevance and accuracy.

A dynamic response in a user interface may be an adaptable and contextually sensitive reaction generated by a system in real-time based on user input and current context. Unlike static responses, which are pre-written and unchanging, dynamic responses are tailored to the specific needs and circumstances of the user at that moment. This involves leveraging real-time data, user preferences, historical interactions, and contextual understanding to craft a reply that is both relevant and personalized. For instance, in a customer service chat, a dynamic response might include pulling up the user's recent purchase history to address a query about an order status or providing location-specific information in response to a travel-related question.

Dynamic responses enhance user experience by making interactions more meaningful and efficient. They can adapt to various input types, whether textual, voice, or even multi-modal interactions, integrating seamlessly with other systems and data sources to provide comprehensive and accurate information. For example, a dynamic response could involve integrating with a weather API to provide up-to-date weather forecasts when a user inquires about the weather, or accessing a database to fetch the latest inventory status when a user asks about product availability. This adaptability not only improves the accuracy and relevance of the responses but also helps in building a more engaging and satisfying user interface, fostering better user engagement and trust in the system.

A conversational response in a user interface may refer to an interactive, natural, and/or fluid reply generated by a system to simulate a human-like conversation. This type of response is designed to create a seamless dialogue between the user and the interface, making interactions feel intuitive and engaging. Unlike simple command-response interactions, conversational responses aim to understand the user's intent, maintain context over multiple exchanges, and respond in a manner that feels natural and coherent. This may involve leveraging advanced natural language processing (NLP) techniques to parse user inputs, recognize intents, and/or generate appropriate replies that are contextually aware and conversationally relevant.

For instance, in a customer support chatbot, a conversational response would not only address the user's immediate query but also anticipate follow-up questions, offer additional helpful information, and use a friendly and approachable tone. The system might remember previous interactions within the same session to provide continuity, such as referring back to earlier parts of the conversation or maintaining user preferences. This type of response helps in creating a more personalized and immersive experience, fostering a sense of engagement and satisfaction. By mimicking human conversational patterns, these responses make the interaction feel more dynamic and less mechanical, enhancing the overall user experience and improving the effectiveness of the interface in achieving its goals.

As described herein, a user action may comprise any action taken by a user. For example, user actions may include clicking, tapping, or selecting items, which are typically used to navigate through menus, activate buttons, or choose options from dropdown lists. Users can also input text through keyboards or on-screen keypads, enabling them to enter search queries, fill out forms, or communicate via chat interfaces. Swiping and scrolling are actions that allow users to move through content on touchscreens or trackpads, making it easier to browse long documents, websites, or image galleries. Dragging and dropping items is another action, often used in organizing files, adjusting the layout of interface elements, or customizing user settings. Voice commands have become increasingly popular, allowing users to interact with the interface through spoken instructions, which can be particularly useful for hands-free operation or accessibility purposes. Additionally, gestures like pinching to zoom, rotating, and flicking are common in touch interfaces, enabling users to manipulate images, maps, or other visual content intuitively. Multi-touch interactions can further enhance the user experience by allowing complex commands involving multiple fingers or hands. Hovering over elements with a mouse cursor can trigger tooltips or additional information, providing context without clicking. Users can also interact with interfaces through hardware controls such as buttons on a remote control, game controller inputs, or physical switches on devices. User actions may also include previous action as well as actions that are not taken. User actions may include other information determined about a user and/or information in a user profile.

In some embodiments, system 100 may be used to generate conversational dynamic responses using a multi-tiered guardrail architecture in data sparse environments. A model guardrail may refer to a set of constraints, practices, or mechanisms designed to ensure that artificial intelligence systems operate safely, ethically, and effectively within predetermined boundaries. These guardrails are implemented to prevent unintended consequences, ensure compliance with legal and ethical standards, and maintain user trust. Implementation typically involves several layers, including technical measures, such as data filtering and algorithmic fairness assessments, and policy-based controls, like usage guidelines and ethical review boards. For instance, a model might have built-in content filters to avoid generating harmful or biased responses. On the organizational level, companies might establish artificial intelligence ethics committees to oversee and audit artificial intelligence deployments, ensuring adherence to internal and external standards. Training and continuous monitoring also play critical roles, where artificial intelligence systems are regularly updated to handle new scenarios ethically and safely, maintaining robustness against evolving threats and misuse.

In some embodiments, generating conversational dynamic responses in data-sparse environments using a multi-tiered guardrail architecture involves strategically leveraging limited data while ensuring the system remains robust, ethical, and compliant. In such settings, artificial intelligence systems may rely on advanced machine learning techniques like few-shot learning, transfer learning, or synthetic data generation to maximize the utility of available data. The multi-tiered guardrail architecture in this context operates at several levels. Firstly, the base tier may involve strict data validation and filtering processes to ensure the quality and relevance of the sparse data being used. The second tier could incorporate algorithmic checks, such as anomaly detection to identify and correct biases or errors that could arise from limited data samples. At a higher level, ethical and compliance guardrails are integrated, involving oversight mechanisms like audit trails and ethical review boards that monitor the system's decisions and intervene when necessary. This layered approach not only helps in maintaining the integrity and safety of the artificial intelligence system but also supports adaptive learning, where the system continuously refines its responses based on new data and feedback, thus gradually improving its performance and reliability in data-sparse environments.

In some embodiments, the guardrails may include input validation to reject inappropriate data, output filters to prevent harmful responses, and algorithms designed to detect and mitigate bias. These mechanisms are often supported by thorough testing and validation phases that simulate various scenarios to check the artificial intelligence's behavior under different conditions. Operationally, guardrails are enforced through policies and procedures that define acceptable use cases and user interactions. This might involve setting up user authentication processes, access controls, and usage monitoring systems to track how the artificial intelligence is being used and by whom. Ethically, implementing guardrails may require the establishment of oversight bodies such as ethics committees, which review and approve artificial intelligence deployments based on predefined ethical guidelines. These committees often play a crucial role in periodic reviews and audits to ensure ongoing compliance with ethical standards.

Artificial intelligence models implement input validation guardrails through a series of techniques designed to ensure that incoming data is accurate, appropriate, and secure before processing. This involves checking inputs against a set of predefined rules and criteria to filter out potentially harmful or irrelevant data. Techniques include type validation, where the system confirms that the data types are as expected (e.g., numerical inputs are not mistakenly treated as strings); range and constraint checking, ensuring values fall within acceptable parameters; and format validation, where inputs must match a specific format (like dates or email addresses). Additionally, sanitization processes are applied to remove any malicious content that could exploit vulnerabilities, such as SQL injections or cross-site scripting attacks in web applications. In more sophisticated setups, artificial intelligence models might use anomaly detection algorithms to identify outliers or unusual patterns that could indicate erroneous or malicious inputs. By implementing these guardrails, artificial intelligence systems are better protected against incorrect data, which helps maintain their reliability, performance, and security. Artificial intelligence models implement similarity validation guardrails by using algorithms designed to assess and ensure the appropriateness of the data relative to the context in which the model operates. This form of validation is crucial when models need to process inputs that should be semantically or contextually similar to data seen during training, thereby maintaining consistency and accuracy in outputs.

To achieve this, artificial intelligence systems often employ techniques such as cosine similarity, Jaccard index, or Euclidean distance, depending on the nature of the data. For instance, in natural language processing (NLP), cosine similarity can be used to compare the vector representations of text inputs to verify their closeness to known, safe topics. In image recognition, Euclidean distance might measure the likeness between feature vectors of an input image and those within a training set. Beyond mere numerical measurements, some models incorporate more advanced machine learning methods like neural networks or clustering algorithms that learn to recognize and group similar inputs during their training phase. This allows the system to dynamically assess whether new inputs fall within acceptable clusters or are anomalies that should be flagged. Implementing these guardrails ensures that the model's responses remain relevant and safe, particularly in interactive applications like chatbots or recommendation systems, where the alignment of input data with the system's training corpus is crucial for performance and user trust.

In some embodiments, artificial intelligence models implement contextual validation guardrails by incorporating mechanisms that assess whether input data makes sense within the specific context of the intended operation. This type of validation is critical to ensure that the artificial intelligence system's responses or actions are appropriate to the situational nuances and do not generate misleading or harmful outcomes. Contextual validation involves analyzing inputs not just on their standalone merits but how they fit within a broader scenario or dataset. For instance, in a financial artificial intelligence application, contextual validation could involve checking transaction amounts against historical account activity to flag transactions that deviate significantly from established patterns, suggesting potential fraud. This can be achieved through the use of context-aware algorithms that incorporate elements of the surrounding data environment into their decision-making processes. These might include temporal data to understand changes over time, geographical information for location-specific decisions, or user behavior patterns for personalized responses. Machine learning models might be trained on enriched datasets that include contextual markers, enabling them to learn not just from the input data but from the context in which that data is used. Additionally, rule-based systems can be applied where predefined context-specific rules are set up to guide data validation-such as time-of-day restrictions on certain types of transactions or content moderation rules that vary by the user's age or location. By implementing such guardrails, artificial intelligence systems are better equipped to handle nuances and complexities of real-world data, making them more reliable and trustworthy for end-users.

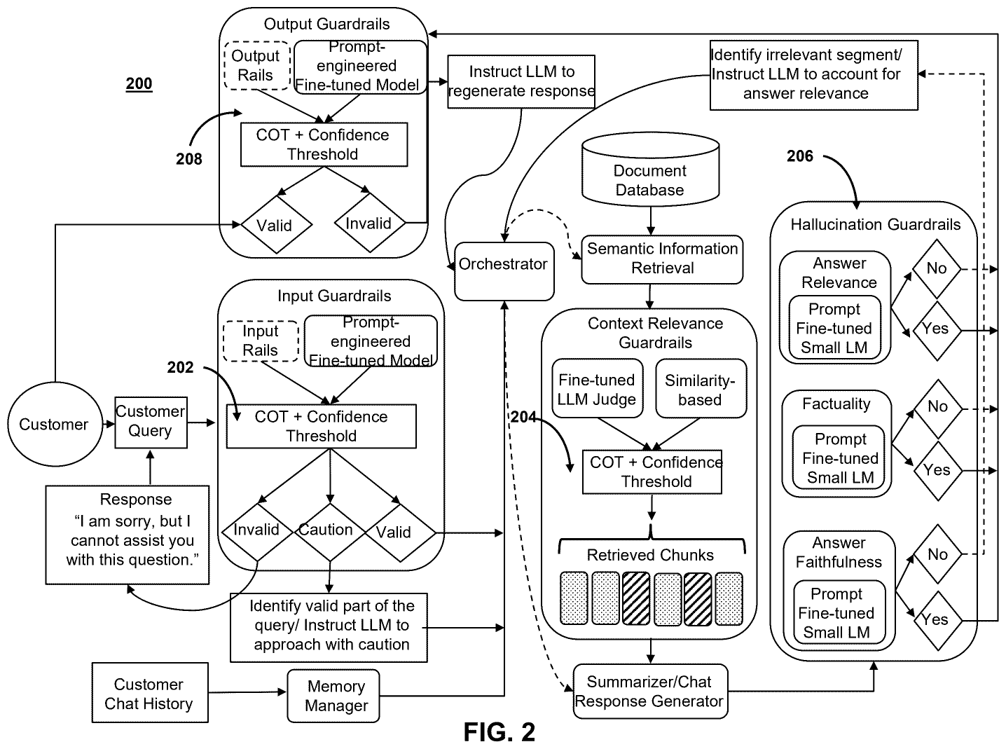

FIG. 2 shows an illustrative diagram for a multi-tiered guardrail architecture, in accordance with one or more embodiments. For example, system 200 may be used to generate conversational dynamic responses using a multi-tiered guardrail architecture in data sparse environments. System 200 is shown with multiple tiers. It should be noted that in some embodiments, system 200 may have any number of models.

In some embodiments, systems 200 is powered by Large Language Models (LLMs). System 200 ensures safety and security of any conversational agent leveraging generative models, which is of utmost importance especially for use cases in the financial sector. System 200 intelligently implements multiple checks and balances throughout the conversation artificial intelligence framework to safeguard both the model from being infiltrated by malicious or unwanted user interactions as well as increase the accuracy of the generated response and monitor these responses for any unwanted outputs by the model. The guardrailing framework is aimed at maximizing capabilities of conversational agents to drastically enhance customer service, without which LLM-powered conversational agents would not be feasible options to replace the current more deterministic, manually monitored services.

LLMs have revolutionized knowledge retrievals through a conversational framework to answer user queries in cohesive, human-like language. This capability makes them a prime candidate to replace the current chatbot use cases across systems to better service both internal and external users with their questions and needs, reducing overheads (both in terms of time and expenses) arising from manual interventions once the current systems in place fail to adequately address these requests. However, one challenge with incorporating LLMs into current systems is that there is inherently less control over the model's response. This imposes risks that need to be thoroughly addressed before LLM-powered conversational agents can fully replace the current system.

System 200 is a comprehensive, multi-tiered model used to impose checks and balances throughout the system to render LLMs (and/or other models) safe and usable for the many conversational artificial intelligence use cases. System 200 can be incorporated into any conversational product or system that leverages LLMs (with or without additional information retrieval components) with minimal modifications, is scalable, and ensures security of the system on multiple fronts in the most comprehensive and computationally efficient manner. Furthermore, system 200 may operate in data sparse environments.

For example, system 200 may be an added framework that can be incorporated in any LLM-powered conversational agent. It is agnostic to the LLM used to handle user interactions, can be seamlessly applied to Information Retrieval (IR) components that are used to augment the model with specific knowledge required to address the user query, and streamline interactions with the user in a more controlled environment to comply with all legal and financial standards.

System 200 may comprise a plurality of guardrails. As described herein, a guardrail may refer to mechanisms or guidelines implemented to ensure that the system operates within safe, ethical, and/or intended boundaries. The guardrails may be designed to prevent the model from generating harmful, biased, or inappropriate content and to guide its behavior towards producing reliable and responsible outputs. Guardrails can include a variety of measures such as pre-defined rules, ethical guidelines, content filters, and continuous monitoring systems. They may be essential in mitigating risks associated with model deployment, particularly in sensitive areas like healthcare, finance, and customer service where the consequences of errors or inappropriate behavior can be significant.

For example, in a conversational model, guardrails may involve filtering out offensive language, preventing the sharing of personal or sensitive information, and ensuring that the model does not provide medical, legal, financial, and/or other advice beyond its scope. These measures may be implemented using a combination of natural language processing techniques to detect and block problematic content, as well as ongoing training and updating of the model to recognize new patterns of inappropriate behavior. Additionally, human oversight may be included as a component of these guardrails, allowing for intervention when the model encounters complex or ambiguous situations. By incorporating guardrails, developers can enhance the trustworthiness and safety of models, ensuring they align with societal values and regulatory standards.

As shown in FIG. 2, system 200 includes four guardrails. In response to a user action (e.g., a query from a customer), system 200 may generate an input to a first guardrail (e.g., guardrail 202). Guardrail 202 may be an input guardrail. Guardrail 202 may be implemented as a first point of interaction with the user. For example, the main function of the input guardrail is to systematically stave off user utterances that raise a host of well-defined red flags, for example malicious or toxic user queries, or any utterance that is deemed not appropriate for the conversational agent to engage with. Guardrail 202 may leverage fine-tuned LLMs and their effective prompt engineering, as well as specially trained Foundational Language Models (FLMs), and can be thought of as a robust multi-tiered fire-wall that imposes multiple checks on the user input to ascertain whether it qualifies to be passed to the conversational agent. Otherwise, it will be flagged, and a commensurate response will be generated by the model to inform the user that their query is in conflict with the product's use case. Additionally or alternatively, the system may be structured such that the verdict from the different components in each multi-tiered implementation of guardrail (for example the input moderation guardrail) are assembled to make a unified decision on which other subsequent decisions must be made.

As shown in FIG. 2, guardrail 202 may generate a plurality of outputs based on the input. The outputs may include an error (e.g., in response to detecting that a confidence threshold is not met), a caution warning (e.g., where part of the input is processed under a caution procedure and/or an alternative portion is generated), and/or a valid output is generated. For example, in response to an error, the system may generate an error description to a user. In contrast, in response to an output, the system may continue to process the initial user action through system 200.

In some embodiments, system 200 may also supplement a user action with other information such as a user's chat history and/or other user information. User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be a digital representation of a person's identity. The data in the user profile may be generated based on the system actively or passively monitoring. Additionally or alternatively, system 200 may pull information from a memory manager and/or other storage location.

System 200 may continue to an orchestrator that may receive outputs from one tier (e.g., guardrail 202) and/or generate inputs for another tier (e.g., guardrail 204). As shown, system 200 may receive inputs from multiple locations (e.g., in response to a tier detecting an error), system 200 may use the orchestrator to redirect and/or modify received inputs and/or outputs. System 200 may use a document database and/or semantic information received from one or more sources to assist in the modification of inputs and/or outputs.

For example, when the orchestrator receives outputs from one tier of the model, it first processes these outputs to ensure they meet the criteria set by the current tier's guardrail. This involves validating the outputs for relevance, accuracy, and adherence to the contextual thresholds established by the specific guardrail. Once validated, the orchestrator determines the next steps based on the predefined workflow and the current state of the interaction.

If the output from the current tier meets the guardrail criteria, the orchestrator prepares this output as an input for the subsequent tier. This preparation may involve reformatting the output, adding additional context, or augmenting it with necessary metadata to ensure it is compatible with the requirements of the next tier. For example, the orchestrator might convert a text output into a numerical vector if the next tier requires such a format for processing. The orchestrator then passes this newly prepared input to the next tier, which features its own guardrail designed to apply different criteria, such as more advanced contextual checks or higher thresholds for accuracy and relevance. This tier processes the input, generating new outputs which are then sent back to the orchestrator.

If the output from the current tier fails to meet the guardrail criteria, the orchestrator may generate an error message or prompt the user for additional information to correct or refine the input. The orchestrator uses the error descriptions and guidance from the guardrail to create these prompts, ensuring they are clear and actionable. Throughout this process, the orchestrator maintains a seamless flow of data and ensures that each tier of the model operates within its designated parameters. By orchestrating the interaction between tiers, it ensures that the system can handle complex tasks and maintain high standards of response quality across different stages of processing. The orchestrator's role is vital in coordinating the inputs and outputs between tiers, enabling the AI model to deliver coherent, accurate, and contextually appropriate responses.

System 200 continues on to guardrail 204. Guardrail 204 may be a context-relevance guardrail. In many instances, the user's query requires information that is not readily available to LLMs at training time, for example, details of their credit card balance. Retrieval Augmented Generation (RAG) is a framework that leverages the emerging in-context learning capability of LLMs by augmenting the user query with retrieved information from external sources of information, along with prompts instructing it on how to use this information and craft an answer. One main limitation of RAG applications is that retrieval of irrelevant information adversely affects performance of the model, thereby harming the interaction of the user with the agent. To ensure passing the most relevant retrieved context to the model, LLMs and FLMs (referred to as critique models) are leveraged to ascertain the relevance of each retrieved piece of information in an orchestrated multi-step, threshold-ed setting. This implementation leverages a recursive framework of retrieval/evaluation and recomposition of the pieces (e.g., “chunks”) of relevant context within the larger retrieved document, which we call the cycle of “retrieve-filter-refine”, until all retrieved contexts pass this guardrail and are then used by the model to generate a response. These critique models are fine-tuned to better discern irrelevant pieces of information in the retrieved context and either filter it out or trigger the retrieval pipeline to look for targeted relevant information rather than a blanket retrieval, enhancing the quality of the augmented knowledge.

Outputs of guardrail 204 may then pass through a response generator. For example, following the determination of a user intent, system 200 may generate a first response (e.g., a first dynamic conversational response”). The response may be input into another tier of system 200 and through guardrail 206 (e.g., a hallucination guardrail).

At guardrail 206, system 200 further processes the user action and/or response currently generated. For example, the other undesirable behavior of RAG-based LLM generations is that the model does not effectively leverage the external information and produces responses that are not grounded in the provided information. System 200 effectively determines parts of the generated response that are either manufactured by the model and not factually consistent with the augmented information, or any key piece of information that is lacking in the response generated by the model to adequately address the user query. A host of checkpoints are designed as part of this guardrail using prompt-engineered LLMs or other FLMs fine-tuned on the task of detecting hallucinations or any lacking information in the model's response. These checks are iteratively repeated until the model's response passes the standards set by this guardrail. For example, if system 200 detects an error at guardrail 206, system 200 may return the output to the orchestrator and/or include a description of the error.

System 200 then includes guardrail 208 (e.g., an output guardrail). Apart from generating faithful and factual responses, system 200 manages the tone and the language of the generated response, as well as preventing the model from uttering certain responses that would violate the legal standards or codes of conduct. Similar to the other guardrails, guardrail 208 incorporates various models and strategies to check the model's response across various dimensions and guidelines to ensure the response presented to the user is in no way offensive, out of line, or in violation of any protocols. If so, the response will undergo transformations by the LLM to address the problematic pieces in the previously generated response with respect to the detected violation(s). If not, the system generates a response that may be presented to the user (e.g., via a user interface).

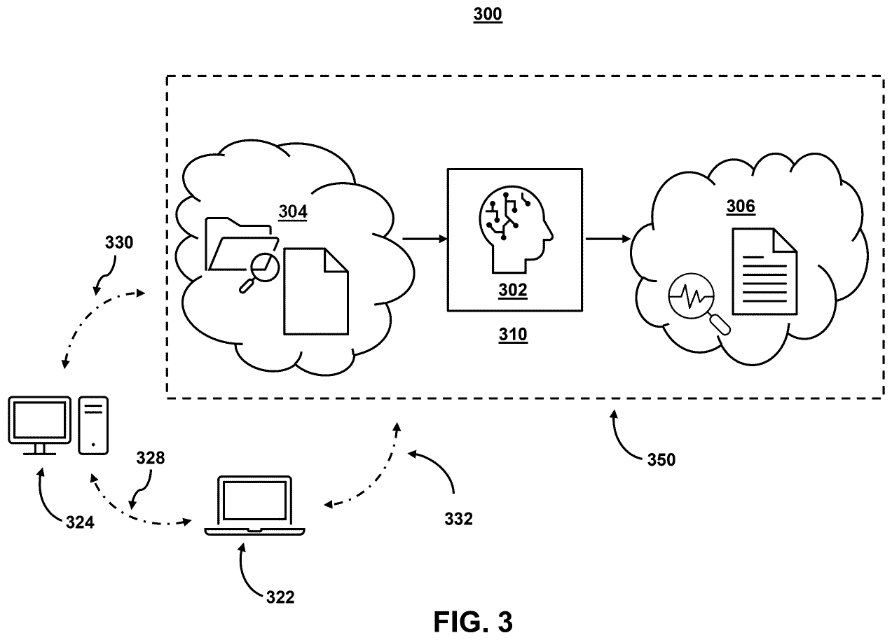

FIG. 3 shows illustrative components for a system used to generating conversational dynamic responses, in accordance with one or more embodiments. For example, FIG. 3 may show illustrative components for generating conversational dynamic responses using a multi-tiered guardrail architecture in data sparse environments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a response based on a user action).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a given response).

In some embodiments, the model (e.g., model 302) may automatically perform actions based on outputs 306. In some embodiments, the model (e.g., model 302) may not perform any actions. The output of the model (e.g., model 302) may be used to generate responses.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDOS protection, and API layer 350 may use RESTful APIs as standard for external integration.

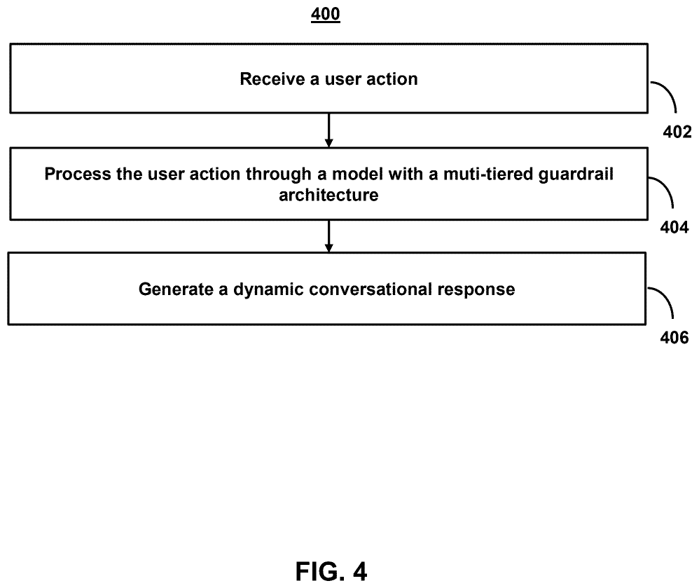

FIG. 4 shows a flowchart of the steps involved in generating conversational dynamic responses, in accordance with one or more embodiments. For example, the system may use process 400 (e.g., as implemented on one or more system components described above) in order to generate conversational dynamic responses using a multi-tiered guardrail architecture in data sparse environments.

At step 402, process 400 (e.g., using one or more components described above) receives a user action. For example, the system may receive a first user action, at a user interface, of an application. For example, the system may receive a first user action at a user interface of an application through actions such as clicking a button, speaking, typing text, performing touch gestures, and/or submitting files or other information. These interactions may be captured by the system as events through event listeners or handlers embedded within the user interface components. When an action is detected, the system generates an event object containing details like the type of event, the target element, the timestamp, and any relevant data, such as the coordinates of a mouse click or the text entered into a field. This event object is then passed to an event handler function defined in the application's code. The handler processes the event and executes the appropriate response, which could involve validating data, sending a request to a backend server, or triggering other application logic. The application then generates a response based on this logic, which may include updating the user interface by displaying a confirmation message, navigating to a new screen, or providing other forms of feedback. Finally, the system delivers feedback to the user, confirming that their action has been received and processed. This feedback can be visual, such as highlighting a button or showing a loading spinner; auditory, like a sound indicating a successful action; or haptic, such as a vibration on a mobile device. This process ensures that user actions are efficiently captured, processed, and responded to, providing a seamless and interactive user experience.

At step 404, process 400 (e.g., using one or more components described above) processes the user action through a model with a multi-tiered guardrail architecture. For example, the system may process the first user action through an artificial intelligence model. The artificial intelligence model may comprise a multi-tiered guardrail architecture. For example, the system may generate a first input based on the first user action. For example, the system may receive input data, which can vary widely depending on the model's purpose—this may be text, images, audio, or other types of data.

The system may process the first input through a first tier of the artificial intelligence model to generate a first output or a first error, wherein the first tier of the artificial intelligence model comprises a first guardrail, and wherein the first guardrail compares the first user action to a listing of prohibited user actions to determine whether to generate the first output or the first error. In the first tier of an artificial intelligence model, which includes a first guardrail, the system begins by capturing the user action, which could be in the form of keywords, text, text strings, words, audio cues, or other inputted actions. This initial step involves preprocessing the input to normalize it and convert it into a structured format that the model can analyze. For text inputs, this might involve tokenization and filtering out irrelevant characters, while for audio cues, it might involve speech-to-text conversion. Once the input is preprocessed, the system compares it against a predefined listing of prohibited user actions. This listing is typically curated based on ethical guidelines, regulatory requirements, specific business rules to prevent harmful or inappropriate content, whitelists, blacklists, keywords, etc. For example, in some embodiments, comparing the first user action to the listing of prohibited user actions to determine whether to generate the first output or the first error further comprises identifying first text corresponding to the first user action, retrieving prohibited text from the listing of prohibited user actions, and determining that the first text does not correspond to the prohibited text.

The comparison process may leverage pattern recognition and matching algorithms to detect any presence of prohibited actions within the user's input. For instance, if the user input contains specific keywords or phrases that are flagged as inappropriate or harmful, the system may recognize these patterns through its matching algorithms. Additionally, more advanced models might use natural language processing (NLP) techniques to understand the context and intent behind the user action, ensuring that even nuanced or implicit prohibited actions are detected. If the comparison indicates that the user action matches any item on the prohibited list, the first guardrail triggers the generation of an error response. This response could be a warning message, an error notification, or an instruction to revise the input. Conversely, if no prohibited actions are detected, the system proceeds to generate the first output, which might be a continuation of the user interaction or a processed response based on the initial input.

In response to determining to generate the first output, the system may generate a second input based on the first output. For example, a system may generate a model input from a previous model output through a process that involves capturing the initial output, transforming it as necessary, and feeding it back into the model for further processing. For example, after preparing the output, the system re-feeds it into the model. This feedback loop allows the model to build upon its previous outputs, maintaining continuity and coherence in tasks that require sequential processing. During this process, the system may also apply any necessary transformations or encodings to ensure the input is in the correct format for the model to process. By iteratively using previous outputs as new inputs, the system can perform complex, multi-step tasks, refining its predictions or responses with each iteration and achieving a more sophisticated and contextually aware performance.

In some embodiments, the system may generate the first output by identifying first text corresponding to the first user action. The system may then identify second text corresponding to the first user action. The system may then retrieve prohibited text from the listing of prohibited user actions. The system may determine that the first text does not correspond to the prohibited text. The system may determine that the second text does correspond to the prohibited text. In response to determining that the first text does not correspond to the prohibited text and the second text does correspond to the prohibited text, the system may generate alternative text for the second text and generate the first output by combining the alternative text and the first text. For example, the system may conduct retrieval of atomic statements from the entire user query, e.g. leveraging LLMs to break down the entire user query into independent statements, and then checking each against the input moderation guardrail.

In some embodiments, generating the first error may comprise the system retrieving a first error description and generating for display, on the user interface, a first error prompt based on the first error description. When the system detects an issue during the execution of an input, such as invalid input, a failure to meet a threshold, and/or a system malfunction, the system may reference an internal database or error-handling module that contains predefined error descriptions. These descriptions provide detailed information about various types of errors, including their causes and potential solutions. The system then selects the appropriate error description corresponding to the detected issue. This error description includes specific details that helps the system understand what went wrong and why. Once the relevant error description is retrieved, the system proceeds to generate an error prompt for display as well as generate information that may be used to re-generate a previous input.

In some embodiments, the system may display an error prompt, which may involve formatting the error description into a user-friendly message that is clear and concise, ensuring that users can quickly grasp the nature of the error and any recommended actions they can take to resolve it. The generated error prompt is then rendered on the user interface, where it is displayed prominently to the user. The prompt typically includes key elements such as an error code or title, a brief explanation of the error, and actionable advice or instructions for resolving the issue. Additionally or alternatively, the errors or guardrail violations are not disclosed to the user. Instead, these identified violations are incorporated either through a prompt instructing a downstream LLM to be aware and act accordingly to suppress these violations, or by rewriting the query (using an LLM) to omit these violations in the first place. This is what happens in the majority of cases. In others, some information may be incorporated in the final answer, letting the user know why part of their query could not be handled.

The system may process the second input through a second tier of the artificial intelligence model to generate a second output or a second error, wherein the second tier of the artificial intelligence model comprises a second guardrail, and wherein the second guardrail compares one or more text strings corresponding to the second input to a contextual relevance threshold to determine whether to generate the second output or the second error. For example, guardrail 204 may comprise a context relevance guardrail that compares each chunk of information/context/text retrieved from a depository of external information to the user input (or the re-written/modified one) to make sure each chunk is actually relevant to the user query. The chunk may then be incorporated in the prompt passed to the LLM to generate a response.

For example, upon receiving the second input, which may be a continuation of a user's query or interaction, the system may first preprocess this input to normalize and tokenize the text, making it suitable for analysis. This preprocessing step ensures that the input is in a consistent format for the model to work with. Once the second input is prepared, it is passed to the second tier of the model, which is specifically designed to handle more nuanced and context-sensitive tasks. This tier incorporates a second guardrail, a mechanism designed to maintain the quality and relevance of the outputs. The second guardrail operates by comparing the text strings from the second input to a predefined contextual relevance threshold. This threshold is established based on the desired criteria for relevance and accuracy, which may include factors such as the coherence of the input with the ongoing interaction, the specificity of the information requested, and the appropriateness of the content.

The model uses sophisticated natural language processing (NLP) techniques to assess the contextual relevance of the second input. In some embodiments, generating the second input based on the first output may comprise the system generating the first output, wherein the first output comprises a first text string and identifying the first text string in the first output, wherein the second input is further based on the first text string.

The system may evaluate how well the input (e.g., a text string) aligns with the expected context, which might involve checking for topic consistency, logical flow, and/or semantic coherence. If the input meets or exceeds the contextual relevance threshold, the model proceeds to generate the second output. This output is crafted to be contextually appropriate and informative, providing a meaningful continuation or response to the user's interaction. However, if the input falls below the contextual relevance threshold, indicating that it is off-topic, incoherent, or otherwise inappropriate, the second guardrail triggers the generation of a second error. By employing this second tier with a guardrail mechanism, the system ensures that all interactions remain relevant and contextually appropriate, thereby enhancing the user experience and maintaining the integrity of the model's responses. This structured approach helps the model manage complex and multi-step interactions effectively, ensuring high-quality outputs and appropriate error handling.

In some embodiments, comparing the one or more text strings corresponding to the second input to the contextual relevance threshold to determine whether to generate the second output or the second error may comprise the system converting the one or more text strings into a numerical vector. The system may retrieve a context vector for the application. The system may determine a similarity between the numerical vector and the context vector and compare the similarity to the contextual relevance threshold. For example, to compare one or more text strings corresponding to a second input to a contextual relevance threshold, the system first converts these text strings into a numerical vector. This process begins with the preprocessing of the input text to normalize and tokenize it, ensuring it is in a format suitable for further analysis. The system then employs an embedding technique, such as Word2Vec, GloVe, or a transformer-based model like BERT, to transform the text into a numerical vector. This embedding captures the semantic meaning of the text in a high-dimensional space, making it possible to perform quantitative comparisons.

Once the text strings are converted into a numerical vector, the system retrieves a context vector that represents the expected or desired context for the application. This context vector is typically precomputed and encapsulates the semantic features of relevant and appropriate responses based on the application's domain and the ongoing interaction. The system then calculates the similarity between the numerical vector of the input text and the context vector. Common similarity measures include cosine similarity, Euclidean distance, or other metrics that quantify how closely the vectors align in the high-dimensional space. Cosine similarity, for instance, measures the cosine of the angle between the two vectors, providing a value between −1 and 1, where higher values indicate greater similarity. After determining the similarity score, the system compares this score to a predefined contextual relevance threshold. This threshold is established based on the desired level of relevance for the application's responses. If the similarity score meets or exceeds the threshold, the system considers the input to be contextually relevant and proceeds to generate the second output. This output is designed to be coherent and appropriate within the context of the ongoing interaction, providing a useful and meaningful response to the user.

However, if the similarity score falls below the threshold, the system determines that the input is not contextually relevant. In this case, the second guardrail is activated, leading the system to generate a second error instead of the intended output. This error message is crafted to inform the user that their input did not align with the expected context and to provide guidance on how to adjust their input to better fit the application's requirements. Additionally or alternatively, if none of the retrieved context from the external data source are relevant to the user query, then, no answer can be found to the user query, and a default response will be sent to the user indicating that no answer if found to their question. However, if some retrieved chunks are irrelevant, the system may not incorporate them into the prompt passed to the LLM to generate a response and no communication will happen to the user. For example, if during each Information Retrieval component (i.e. RAG) three out of six retrieved chunks are irrelevant, then the remaining three will be used. Otherwise, if six out of six chunks are determined to be irrelevant to the user query, then a default answer will be passed to the user that their question cannot be answered at this time. By converting text strings into numerical vectors and comparing these to a context vector using similarity measures, the system effectively ensures that the responses generated are contextually relevant, enhancing the user experience and maintaining the integrity of the interaction.

In some embodiments, generating the second error may comprise the system retrieving a second error description and re-generating the second input based on the first output and the second error description. For example, the system may retrieve the second error description from an internal database or error-handling module. This error description is predefined and includes details about the nature of the error, potential causes, and guidance on how to correct it.

At step 406, process 400 (e.g., using one or more components described above) generates a dynamic conversational response. For example, in response to determining to generate the second output, the system may generate a first dynamic conversational response.

In some embodiments, generating the first dynamic conversational response may comprise the system generating a third input based on the second output, wherein the third input comprises the first dynamic conversational response. The system may then process the third input through a third tier of the artificial intelligence model to generate a third output or a third error, wherein the third tier of the artificial intelligence model comprises a third guardrail, and wherein the third guardrail compares a plurality of fine-tuned small (or large) language models.

For example, the system may take the second output, which is the result of the previous user interaction or model processing, and use it as a foundation to create the third input. This third input is designed to encapsulate the first dynamic conversational response, aiming to continue the dialogue in a coherent and contextually appropriate manner. Once the third input is formulated, the system processes it through a third tier of the model. This tier is specifically designed for more sophisticated conversational management and incorporates a third guardrail to ensure the quality and relevance of the response. The third guardrail is a critical component that compares the third input against a plurality of fine-tuned small or large language models. These models are specialized and trained on specific aspects of conversation, such as maintaining context, managing dialogue flow, and providing accurate information based on the user's needs. More specifically, ensuring that the information provided to the model through the RAG component is correctly used in the response generated by the LLM, e.g., there are no hallucinations in the response and that the information in the response may be “grounded” in the external context retrieved through the RAG component. As the system processes the third input, it runs it through each of these fine-tuned models to gather insights and potential responses. Each model evaluates the input based on its training and specialization, contributing to a comprehensive analysis of the input's relevance and appropriateness. The third guardrail then aggregates the outputs from these small (or large) language models, comparing them to ensure consistency and contextual alignment with the ongoing conversation. This comparison helps to filter out any responses that do not meet a threshold or are otherwise inappropriate. For example, in some embodiments, each of the three components in the hallucination guardrail (e.g., guardrail 206 (FIG. 2)) are comprised of multiple mechanisms to perform their respective checks. They all leverage LLMs (that can be fine-tuned for these specific tasks) through prompts, as well as fine-tuned SLM's to provide a confidence threshold on the existence of each guardrail violation. Then, these different verdicts are assembled to provide a final decision on whether 1) the answer is relevant to the user query, 2) the answer is factual based on the retrieved information, 3) the answer does not hallucinate information that is not included in the retrieved context.

If the aggregated analysis from the fine-tuned models meets the predefined contextual relevance threshold, the system generates the third output, which constitutes the first dynamic conversational response. This output is then presented to the user, continuing the dialogue in a manner that is contextually rich and dynamically responsive to the user's needs. However, if the input fails to meet the threshold, the third guardrail triggers the generation of a third error, providing feedback to the user about why the response was not suitable and guiding them on how to proceed. Alternatively or additionally, the error is again not communicated to the user. Instead, the error may be passed to the orchestrator to inform that some form of hallucination exists, and the model pays more attention in the next round to avoid the hallucinated segments in the previous answer. This process can be recursive, i.e., it can be repeated more than once. But if it surpasses a set threshold, then a default answer will be sent to the user that a response cannot be synthesized at this point, and this instance will be logged to then be used as a training example to improve the performance of the fine-tuned LLMs/SLMS with respect to hallucination detection. However, these failure instances comprise only a low percentage of all user interactions.

By leveraging a series of fine-tuned language models and an advanced tier with a third guardrail, the system ensures that the dynamic conversational response is not only accurate and relevant but also adaptable to the nuances of the ongoing interaction. This multi-tiered approach enhances the system's ability to manage complex dialogues and deliver high-quality, contextually appropriate responses, thereby improving the overall user experience.

In some embodiments, the plurality of fine-tuned language models may comprise a first fine-tuned small/large language models trained on a first dataset to determine an answer relevance for the second output, a second fine-tuned small/large language models trained on a second dataset to determine a factuality for the second output, and a third fine-tuned small/large language model trained on a third dataset to determine an answer faithfulness for the second output. It should be noted that guardrails are not limited to small LMs, but may use both small and large LM's at each point, and a final answer is chosen based on the verdict on different model for each of the three checks to make a final decision. Additionally, one or more decisions made be generated simultaneously to prevent latency.

For example, the system may integrate multiple specialized models to evaluate different aspects of a response. The first fine-tuned language model is trained on a dataset focused on answer relevance. This model evaluates the second output to determine how well it addresses the user's query or fits within the context of the ongoing conversation. By analyzing the input, the model ensures that the response directly pertains to the user's needs and maintains the conversation's relevance. The second fine-tuned language model is trained on a dataset centered on factuality. This model assesses the second output to verify the accuracy of the information provided. It cross-references the details within the output against a reliable dataset to confirm that the facts presented are correct and trustworthy. The third fine-tuned language model, which is trained on a dataset aimed at ensuring answer faithfulness, evaluates the second output. This model checks that the generated response remains true to the source material and the context of the conversation. It ensures that the response does not introduce any distortions or misinterpretations of the original input, preserving the integrity and consistency of the dialogue.

The system may then aggregate the evaluations from these three models (or handle individually). It integrates the relevance, factuality, and faithfulness scores to form a comprehensive assessment of the second output. If the evaluations meet predefined thresholds, the system considers the response suitable. However, if any of the models flag issues—such as a relevance mismatch, factual inaccuracy, or lack of faithfulness—the system may modify the output and/or provide feedback to the user to adjust their input. For example, in some embodiments, generating the third error may comprise the system retrieving a third error description and re-generating the second input based on the first output and the third error description.

In some embodiments, the system may generate a fourth input based on the third output and process the fourth input through a fourth tier of the artificial intelligence model to generate a fourth output or a fourth error, wherein the fourth tier of the artificial intelligence model comprises a fourth guardrail, and wherein the fourth guardrail compares the fourth input to a confidence threshold to determine whether to generate the fourth output or the fourth error.

The system may generate the third output from the preceding tier, this third output serves as the foundation for creating the fourth input. This transformation involves contextualizing the third output to ensure it aligns with the ongoing interaction and addresses any new or continuing user queries or tasks. Once the fourth input is formulated, the system processes it through the fourth tier of the model. This tier is specifically designed to handle complex interactions and ensure the responses are not only accurate but also reliable. Integral to this tier is the fourth guardrail, a mechanism that ensures the integrity of the responses by comparing the fourth input to a confidence threshold. The process begins by converting the fourth input into a numerical representation, often through embedding techniques that capture the semantic meaning of the text. This numerical representation is then analyzed by the model to generate a potential fourth output. The model uses its trained parameters and patterns learned from extensive datasets to produce this output, aiming to maintain coherence and relevance to the user's request.

Before finalizing this output, the fourth guardrail comes into play. This guardrail assesses the generated fourth output by calculating a confidence score, which quantifies the model's certainty regarding the accuracy and appropriateness of the response. The confidence score is derived from various factors, including the model's internal metrics, the consistency of the output with the input context, and historical performance data. The system then compares this confidence score against a predefined confidence threshold. If the confidence score meets or exceeds the threshold, the system proceeds to finalize and generate the fourth output. This output is then presented to the user, ensuring that it is both reliable and contextually appropriate. However, if the confidence score falls below the threshold, the system triggers the fourth guardrail to generate a fourth error instead. This error is carefully constructed to inform the user about the issue, explaining that the system lacks sufficient confidence in the response. The error message often includes suggestions for refining the input or additional instructions to guide the user toward a more precise query. For example, in some embodiments, generating the fourth error may comprise the system retrieving a fourth error description and re-generating the second input based on the first output and the fourth error description.

In some embodiments, the system may determine a second dynamic conversational response based on the fourth output. The system may then generate for display, on the user interface, the second dynamic conversational response. For example, after generating the fourth output, the system evaluates this output to decide the appropriate type of response-whether to proceed with the first conversational response or switch to a second dynamic conversational response. The system may analyze the content and context of the fourth output. This may involve checking the relevance, coherence, and completeness of the information provided. The fourth output is examined to see if it effectively addresses the user's query or if it prompts the need for a more dynamic and engaging response. Factors such as the complexity of the user's request, the nature of the conversation, and the need for deeper engagement are considered. If the fourth output suggests that the user's query is straightforward and adequately answered, the system may generate the first conversational response, which is typically more direct and to the point. This response would focus on delivering the required information or completing the task in a clear and concise manner. However, if the fourth output indicates that the user's query is complex, open-ended, or requires further elaboration, the system opts for a second dynamic conversational response. This type of response is designed to be more interactive, engaging, and adaptive to the user's needs. The system uses the fourth output as a basis to craft a response that encourages further interaction, provides additional context, or explores the topic in greater depth.

To generate this second dynamic conversational response, the system might employ advanced natural language generation techniques to create a response that is not only informative but also prompts the user for more input or offers additional insights. This dynamic response aims to maintain a natural and flowing conversation, making the interaction feel more personalized and responsive to the user's needs. The decision to generate a second dynamic conversational response is also influenced by the system's evaluation of user engagement metrics, historical data on similar interactions, and predefined conversational strategies aimed at enhancing user satisfaction. By considering these factors, the system ensures that the chosen response type aligns with the conversational goals and provides a richer user experience.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for generating conversational dynamic responses using a multi-tiered guardrail architecture in data sparse environments.
2. The method in the preceding embodiment, receiving a first user action, at a user interface, of an application; processing the first user action through an artificial intelligence model, wherein processing the artificial intelligence model comprises: generating a first input based on the first user action; processing the first input through a first tier of the artificial intelligence model to generate a first output or a first error, wherein the first tier of the artificial intelligence model comprises a first guardrail, wherein the first guardrail compares the first user action to a listing of prohibited user actions to determine whether to generate the first output or the first error; in response to determining to generate the first output, generating a second input based on the first output; processing the second input through a second tier of the artificial intelligence model to generate a second output or a second error, wherein the second tier of the artificial intelligence model comprises a second guardrail, wherein the second guardrail compares one or more text strings corresponding to the second input to a contextual relevance threshold to determine whether to generate the second output or the second error; and in response to determining to generate the second output, generating a first dynamic conversational response.
3. The method of any one of the preceding embodiments, wherein comparing the first user action to the listing of prohibited user actions to determine whether to generate the first output or the first error further comprises: identifying first text corresponding to the first user action; retrieving prohibited text from the listing of prohibited user actions; and determining that the first text does not correspond to the prohibited text.
4. The method of any one of the preceding embodiments, wherein generating the first output further comprises: identifying first text corresponding to the first user action; identifying second text corresponding to the first user action; retrieving prohibited text from the listing of prohibited user actions; determining that the first text does not correspond to the prohibited text; determining that the second text does correspond to the prohibited text; and in response to determining that the first text does not correspond to the prohibited text and the second text does correspond to the prohibited text: generating alternative text for the second text; and generating the first output by combining the alternative text and the first text.
5. The method of any one of the preceding embodiments, wherein generating the first error comprises: retrieving a first error description; and generating for display, on the user interface, a first error prompt based on the first error description.
6. The method of any one of the preceding embodiments, wherein generating the second input based on the first output further comprises: generating the first output, wherein the first output comprises a first text string; and identifying the first text string in the first output, wherein the second input is further based on the first text string.
7. The method of any one of the preceding embodiments, wherein comparing the one or more text strings corresponding to the second input to the contextual relevance threshold to determine whether to generate the second output or the second error further comprises: converting the one or more text strings into a numerical vector; retrieving a context vector for the application; determining a similarity between the numerical vector and the context vector; and comparing the similarity to the contextual relevance threshold.
8. The method of any one of the preceding embodiments, wherein generating the second error comprises: retrieving a second error description; and re-generating the second input based on the first output and the second error description.
9. The method of any one of the preceding embodiments, wherein generating the first dynamic conversational response further comprises: generating a third input based on the second output, wherein the third input comprises the first dynamic conversational response; and processing the third input through a third tier of the artificial intelligence model to generate a third output or a third error, wherein the third tier of the artificial intelligence model comprises a third guardrail, wherein the third guardrail compares a plurality of fine-tuned language models.
10. The method of any one of the preceding embodiments, wherein the plurality of fine-tuned language models comprise a first fine-tuned language model trained on a first dataset to determine an answer relevance for the second output, a second fine-tuned language model trained on a second dataset to determine a factuality for the second output, and a third fine-tuned language model trained on a third dataset to determine an answer faithfulness for the second output.
11. The method of any one of the preceding embodiments, wherein generating the third error comprises: retrieving a third error description; and re-generating the second input based on the first output and the third error description.
12. The method of any one of the preceding embodiments, further comprising: generating a fourth input based on the third output; and processing the fourth input through a fourth tier of the artificial intelligence model to generate a fourth output or a fourth error, wherein the fourth tier of the artificial intelligence model comprises a fourth guardrail, wherein the fourth guardrail compares the fourth input to a confidence threshold to determine whether to generate the fourth output or the fourth error.
13. The method of any one of the preceding embodiments, wherein generating the fourth error comprises: retrieving a fourth error description; and re-generating the second input based on the first output and the fourth error description.
14. The method of any one of the preceding embodiments, further comprising: determining a second dynamic conversational response based on the fourth output; and generating for display, on the user interface, the second dynamic conversational response.
15. One or more non-transitory, computer-readable mediums storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for generating conversational dynamic responses using a multi-tiered guardrail architecture in data sparse environments, the system comprising:
one or more processors; and
one or more non-transitory, computer-readable mediums, comprising instructions that, when executed by the one or more processors, cause operations comprising:
receiving a first user action, at a user interface, of an application;
processing the first user action through an artificial intelligence model, wherein processing the artificial intelligence model comprises:
generating a first input based on the first user action;
processing the first input through a first tier of the artificial intelligence model to generate a first output or a first error, wherein the first tier of the artificial intelligence model comprises a first guardrail, and wherein the first guardrail compares the first user action to a listing of prohibited user actions to determine whether to generate the first output or the first error;
in response to determining to generate the first output, generating a second input based on the first output;
processing the second input through a second tier of the artificial intelligence model to generate a second output or a second error, wherein the second tier of the artificial intelligence model comprises a second guardrail, and wherein the second guardrail compares one or more text strings corresponding to the second input to a contextual relevance threshold to determine whether to generate the second output or the second error;
in response to determining to generate the second output, generating a third input based on the second output, wherein the third input comprises a first dynamic conversational response;
processing the third input through a third tier of the artificial intelligence model to generate a third output or a third error, wherein the third tier of the artificial intelligence model comprises a third guardrail, and wherein the third guardrail compares a plurality of fine-tuned language models;
generating a fourth input based on the third output;
processing the fourth input through a fourth tier of the artificial intelligence model to generate a fourth output or a fourth error, wherein the fourth tier of the artificial intelligence model comprises a fourth guardrail, wherein the fourth guardrail compares the fourth input to a confidence threshold to determine whether to generate the fourth output or the fourth error; and
generating for display, on the user interface, a second dynamic conversational response based on the fourth output.

2. A method of generating conversational dynamic responses using a multi-tiered guardrail architecture in data sparse environments, the method comprising:
receiving a first user action, at a user interface, of an application;
processing the first user action through an artificial intelligence model, wherein processing the artificial intelligence model comprises:
generating a first input based on the first user action;
processing the first input through a first tier of the artificial intelligence model to generate a first output or a first error, wherein the first tier of the artificial intelligence model comprises a first guardrail, and wherein the first guardrail compares the first user action to a listing of prohibited user actions to determine whether to generate the first output or the first error;
in response to determining to generate the first output, generating a second input based on the first output;
processing the second input through a second tier of the artificial intelligence model to generate a second output or a second error, wherein the second tier of the artificial intelligence model comprises a second guardrail, wherein the second guardrail compares one or more text strings corresponding to the second input to a contextual relevance threshold to determine whether to generate the second output or the second error; and
in response to determining to generate the second output, generating a first dynamic conversational response.

3. The method of claim 2, wherein comparing the first user action to the listing of prohibited user actions to determine whether to generate the first output or the first error further comprises:
identifying first text corresponding to the first user action;
retrieving prohibited text from the listing of prohibited user actions; and
determining that the first text does not correspond to the prohibited text.

4. The method of claim 2, wherein generating the first output further comprises:
identifying first text corresponding to the first user action;
identifying second text corresponding to the first user action;
retrieving prohibited text from the listing of prohibited user actions;
determining that the first text does not correspond to the prohibited text;
determining that the second text does correspond to the prohibited text; and
in response to determining that the first text does not correspond to the prohibited text and the second text does correspond to the prohibited text:
generating alternative text for the second text; and
generating the first output by combining the alternative text and the first text.

5. The method of claim 2, wherein generating the first error comprises:
retrieving a first error description; and
generating for display, on the user interface, a first error prompt based on the first error description.

6. The method of claim 2, wherein generating the second input based on the first output further comprises:
generating the first output, wherein the first output comprises a first text string; and
identifying the first text string in the first output, wherein the second input is further based on the first text string.

7. The method of claim 2, wherein comparing the one or more text strings corresponding to the second input to the contextual relevance threshold to determine whether to generate the second output or the second error further comprises:
converting the one or more text strings into a numerical vector;
retrieving a context vector for the application;
determining a similarity between the numerical vector and the context vector; and
comparing the similarity to the contextual relevance threshold.

8. The method of claim 2, wherein generating the second error comprises:
retrieving a second error description; and
re-generating the second input based on the first output and the second error description.

9. The method of claim 2, wherein generating the first dynamic conversational response further comprises:
generating a third input based on the second output, wherein the third input comprises the first dynamic conversational response; and
processing the third input through a third tier of the artificial intelligence model to generate a third output or a third error, wherein the third tier of the artificial intelligence model comprises a third guardrail, and wherein the third guardrail compares a plurality of fine-tuned language models.

10. The method of claim 9, wherein the plurality of fine-tuned language models comprise a first fine-tuned language model trained on a first dataset to determine an answer relevance for the second output, a second fine-tuned language model trained on a second dataset to determine a factuality for the second output, and a third fine-tuned language model trained on a third dataset to determine an answer faithfulness for the second output.

11. The method of claim 9, wherein generating the third error comprises:
retrieving a third error description; and
re-generating the second input based on the first output and the third error description.

12. The method of claim 9, further comprising:
generating a fourth input based on the third output; and
processing the fourth input through a fourth tier of the artificial intelligence model to generate a fourth output or a fourth error, wherein the fourth tier of the artificial intelligence model comprises a fourth guardrail, wherein the fourth guardrail compares the fourth input to a confidence threshold to determine whether to generate the fourth output or the fourth error.

13. The method of claim 12, wherein generating the fourth error comprises:
retrieving a fourth error description; and
re-generating the second input based on the first output and the fourth error description.

14. The method of claim 12, further comprising:
determining a second dynamic conversational response based on the fourth output; and
generating for display, on the user interface, the second dynamic conversational response.

15. One or more non-transitory, computer-readable mediums, comprising instructions that, when executed by one or more processors, cause operations comprising:
processing a first user action through an artificial intelligence model, wherein processing the artificial intelligence model comprises:
generating a first input based on the first user action;
processing the first input through a first tier of the artificial intelligence model to generate a first output or a first error, wherein the first tier of the artificial intelligence model comprises a first guardrail, wherein the first guardrail compares the first user action to a listing of prohibited user actions to determine whether to generate the first output or the first error;
in response to determining to generate the first output, generating a second input based on the first output;
processing the second input through a second tier of the artificial intelligence model to generate a second output or a second error, wherein the second tier of the artificial intelligence model comprises a second guardrail, wherein the second guardrail compares one or more text strings corresponding to the second input to a contextual relevance threshold to determine whether to generate the second output or the second error; and
in response to determining to generate the second output, generating a first dynamic conversational response.

16. The one or more non-transitory, computer-readable mediums of claim 15, wherein comparing the first user action to the listing of prohibited user actions to determine whether to generate the first output or the first error further comprises:
identifying first text corresponding to the first user action;
retrieving prohibited text from the listing of prohibited user actions; and
determining that the first text does not correspond to the prohibited text.

17. The one or more non-transitory, computer-readable mediums of claim 15, wherein generating the first output further comprises:
identifying first text corresponding to the first user action;
identifying second text corresponding to the first user action;
retrieving prohibited text from the listing of prohibited user actions;
determining that the first text does not correspond to the prohibited text;
determining that the second text does correspond to the prohibited text; and
in response to determining that the first text does not correspond to the prohibited text and the second text does correspond to the prohibited text:
generating alternative text for the second text; and
generating the first output by combining the alternative text and the first text.

18. The one or more non-transitory, computer-readable mediums of claim 15, wherein generating the first error comprises:
retrieving a first error description; and
generating for display, on a user interface, a first error prompt based on the first error description.

19. The one or more non-transitory, computer-readable mediums of claim 15, wherein generating the second input based on the first output further comprises:
generating the first output, wherein the first output comprises a first text string; and
identifying the first text string in the first output, wherein the second input is further based on the first text string.

20. The one or more non-transitory, computer-readable mediums of claim 15, wherein comparing the one or more text strings corresponding to the second input to the contextual relevance threshold to determine whether to generate the second output or the second error further comprises:
converting the one or more text strings into a numerical vector;
retrieving a context vector;
determining a similarity between the numerical vector and the context vector; and
comparing the similarity to the contextual relevance threshold.
